(19) United States
(12) Patent Application Publication
(10) Pub. No.: US 2022/0329133 A1
(43) Pub. Date: Oct. 13, 2022

(54) METHOD OF MANUFACTURING AN ENCAPSULATED ELECTROMAGNETIC COIL WITH AN INTENTIONALLY ENGINEERED HEAT FLOW PATH

(71) Applicant: HONEYWELL INTERNATIONAL INC., Charlotte, NC (US)

(72) Inventors: Bahram Jadidian, Morris Plains, NJ (US); Eric Passman, Morris Plains, NJ (US); Mahdi Mohajeri, Morris Plains, NJ (US)

(73) Assignee: HONEYWELL INTERNATIONAL INC., Charlotte, NC (US)

(21) Appl. No.: 17/228,890

(22) Filed: Apr. 13, 2021

(51) Int. Cl. H02K 9/22; H02K 3/34; H02K 3/38

(52) U.S. Cl. CPC H02K 9/22; H02K 3/345; H02K 3/38

(57) ABSTRACT

A method for manufacturing an electromagnetic coil with an intentionally engineered heat flow path is provided. The method includes defining at least one preferential heat flow path for heat to flow for the electromagnetic coil. A coil cartridge in which to encase the electromagnetic coil is designed by selecting dimensions of different portions of the insulating coil cartridge that will result in the at least one preferential heat flow path. The electromagnetic coil is then encased in coil cartridge material to produce an encased electromagnetic coil.

### TECHNICAL FIELD

The present invention generally relates to encapsulated electromagnetic coils, and more particularly relates to a method of manufacturing an encapsulated coil with an intentionally engineered heat flow path for extreme operating conditions.

### BACKGROUND

Electric motors are used in a myriad of systems and environments. They can generate relatively large amounts of heat during powered operation. More specifically, during motor operation, current flow through the electromagnetic coils causes heat to be generated due, in part, to the resistance of the coils. This heat causes the coil and device temperatures to rise. As the coil temperatures increases, the generated heat is typically transferred from the coils toward area(s) with lower temperatures. The higher the temperature the coils and motor assembly can handle, the higher the power density of the motor.

As may be appreciated, the heat that is generated in, and transferred away from, the electromagnetic coils, can increase the temperatures of various other components to undesirable levels. As such, the operational temperature of most conventional electromagnetic coils is limited to less than 250° C. for devices making use of polyamide wire electrical insulation. This consequently imposes limits on the applied current and/or electrical potential to the electromagnetic coils, as well as the ambient conditions surrounding the motor. This, in turn, limits the achievable power density, and potential operating environments, of the motor (or other electromagnetic device).

Improving the thermal management of electromagnetic devices, such as electric motors, has the potential to dramatically reduce overall size and improve overall efficiency while further improving the power density. The efficiency improvements can be realized by reducing the additional power draw and/or system complexity required for cooling system add-ons to keep the electromagnetic device cool. The ability to operate the electromagnetic device with increased power input and/or at higher temperature would also increase power density.

Hence, there is a need for a method of improving the overall thermal management of electromagnetic devices. The present invention addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a method for manufacturing an electromagnetic coil with an intentionally engineered heat flow path includes defining at least one preferential heat flow path for heat to flow for the electromagnetic coil. A coil cartridge in which to encase the electromagnetic coil is designed by selecting dimensions of different portions of the coil cartridge that will result in the at least one preferential heat flow path. The electromagnetic coil is then encased in coil cartridge material to thereby produce an encased electromagnetic coil.

In another embodiment, a method for manufacturing a motor stator assembly includes providing a stator structure having at least a plurality of spaced-apart stator poles, where each of the spaced-apart stator poles extends radially from the stator structure. At least one preferential heat flow path for heat to flow for each of a plurality of electromagnetic coils is defined. An associated coil cartridge for each of the electromagnetic coils is designed by selecting dimensions of different portions of each of the associated coil cartridges that will result in the at least one preferential heat flow path for each of the electromagnetic coils. Each of the electromagnetic coils is encased in coil cartridge material to produce a plurality of encased electromagnetic coils, and each of the plurality of encased electromagnetic coils is disposed around a different one of the stator poles.

Furthermore, other desirable features and characteristics of the electromagnetic coil manufacturing method will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a simplified schematic cross-sectional view of one embodiment of a motor;

FIG. 2 depicts a simplified schematic cross-sectional view of one embodiment of an encased electromagnetic coil cartridge that may be used in the motor of FIG. 1;

FIG. 3 depicts a process, in flowchart form, that may be used to manufacture the encased electromagnetic coil of FIG. 2;

FIG. 4 depicts one embodiment of a physical implementation of an encased electromagnetic coil manufactured using the process of FIG. 3;

FIG. 5 depicts a cross-sectional view of the encased electromagnetic coil cartridge taken alone 5-5 in FIG. 2; and

FIGS. 6-8 each depict how various surface contours can be formed in one or more surfaces to define various contact points.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. Moreover, as used herein, the phrase “heat flow property(ies)” encompasses both thermal conductivity and thermal diffusivity. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

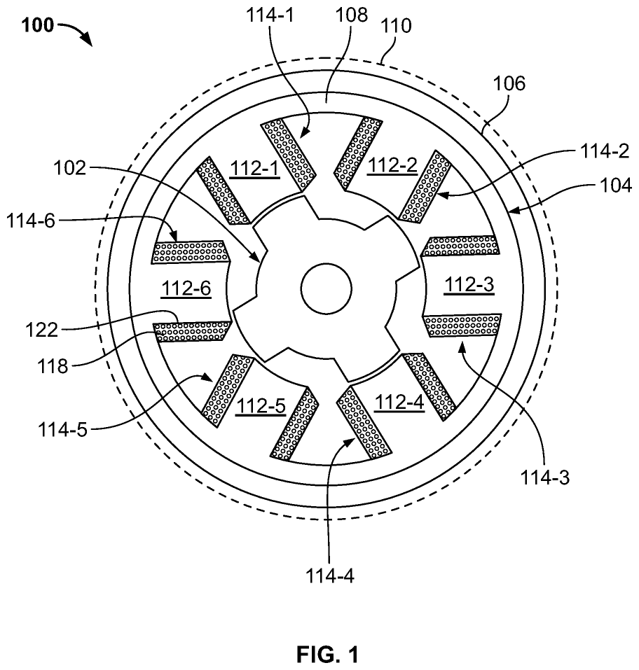

Referring first to FIG. 1, a simplified schematic cross-sectional view of one embodiment of a motor 100 is depicted. The motor 100 includes a rotor 102 and a stator 104. The rotor 102 is mounted for rotation and is configured, upon receiving a drive torque, to rotate relative to the stator 104. The stator 104 at least partially surrounds the rotor 102 and includes at least a stator housing 106, a stator structure 108, which includes a plurality of spaced-apart stator poles 112 (112-1, 112-2, 112-3, . . . 112-6), and a plurality of encased electromagnetic coils 114 (114-1, 114-2, 114-2, . . . 114-6). Before proceeding further, it is noted that although the depicted motor 100 is configured as a switched reluctance motor, it will be appreciated that the techniques described herein apply to numerous other motor configurations and to numerous other types of electromagnetic devices.

Returning to the description, it is seen that the stator structure 108 is disposed within the stator housing 106 via, for example, a shrink fit or a press fit, and has a plurality of end bells 110 coupled thereto. For clarity and ease of depiction, only one end bell 110 is depicted and is done so using dotted lines. In the depicted embodiment, the stator structure 108 surrounds the rotor 102, and each of the stator poles 112 extends radially inwardly from the stator structure 108 toward the rotor 102. It will be appreciated, however, that in other embodiments each of the stator poles 112 may be joined to a ring at the inner diameter of the stator structure 108 and extend radially outwardly.

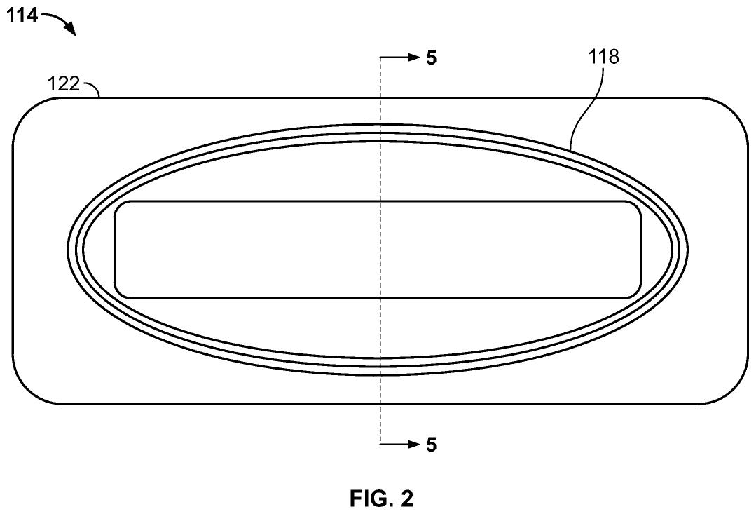

In the depicted embodiment, each of the encased electromagnetic coils 114 disposed around a different one of the stator poles 112. Each encased electromagnetic coil 114 includes an electromagnetic coil 118 that is encased in a coil cartridge 122. For completeness, a simplified cross-sectional view of one embodiment of an encased electromagnetic coil 114 is depicted in FIG. 2. It should be noted that although the electromagnetic coil 118 depicted in FIG. 2 (and in other figures) has a generally symmetric, elliptical shape, this shape is only exemplary of one embodiment. In other embodiments, the electromagnetic coil 118 may be formed into various shapes, both symmetric and non-symmetric, as needed or desired to establish a preferential heat flow path, as will now be described.

Each of the encased electromagnetic coils 114 is manufactured with an intentionally engineered heat flow path such that heat that is generated in the electromagnetic coil 118 flows along at least one preferential heat flow path. For the motor 100 depicted in FIG. 1, the at least one preferential heat flow path may be one or more of an axially directed heat flow path toward the end bells 110, a radially directed heat flow path toward or away from the stator housing 106, an inwardly directed heat flow path toward the stator pole 112 around which the encased electromagnetic coil 114 is disposed, and an outwardly directed heat flow path toward an adjacent encased electromagnetic coil 114.

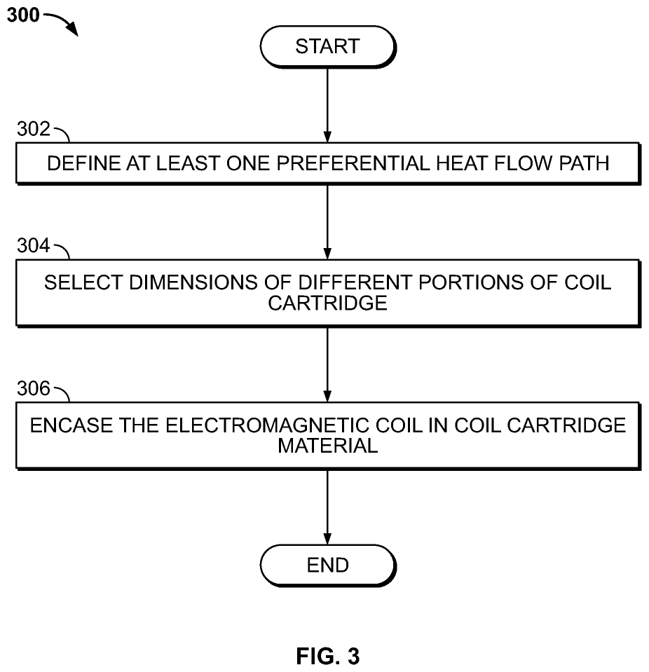

The method by which each encased electromagnetic coil 114 is manufactured to exhibit the intentionally engineered heat flow path will now be described. In doing so, reference should be made to FIG. 3, which depicts the general process 300 in flowchart form. Moreover, the parenthetical numeric references in the following description refer to like-numbered process symbols in the flowchart. Before describing the process in detail, it should also be noted that the heat generated in the electromagnetic coil 118 will be defined in advance using conventional thermal analysis and modeling, which is related to power density, length, number of turns, and material. Moreover, because the electromagnetic coil 118 exhibits relatively high heat flow properties, it is assumed that the temperature thereof will be uniform.

With the above in mind, and as FIG. 3 depicts, the process 300 begins by defining at least one preferential heat flow path for heat to flow from the electromagnetic coil 118 (302). The coil cartridge 122 for the electromagnetic coil 118 is then designed by selecting dimensions of different portions the coil cartridge 122 that will result in the at least one preferential heat flow path from the electromagnetic coil 118 (304). The electromagnetic coil 118 is then encased in coil cartridge material (306) to produce an encased electromagnetic coil 114.

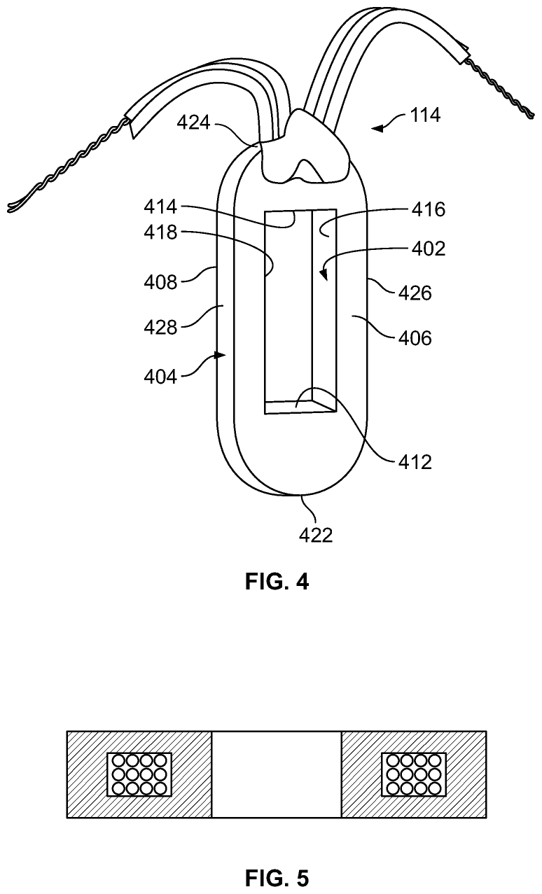

It will be appreciated that the step of selecting the dimensions of different portions of the coil cartridge 122 may include implementing one or more techniques, some of which will now be described. In doing so, reference will be made to an example embodiment of an encased electromagnetic coil 114 manufactured in accordance with the above-described process 300. This embodiment, which is depicted in FIG. 4, has a plurality of surfaces, which include an inner peripheral surface 402, an outer peripheral surface 404, a front facing surface 406, and a rear facing surface 408 (not visible). The inner peripheral surface 402 defines an inner first end 412, an inner second end 414, an inner first lateral side 416, and an inner second lateral side 418. Similarly, the outer peripheral surface 404 defines an outer first end 422, an outer second end 424, an outer first lateral side 426, and an outer second lateral side 428.

One dimensional selection technique includes selecting different thicknesses in different portions of the coil cartridge 122. For example, in the embodiment depicted in FIG. 4, the thicknesses between the inner first and second ends 412, 414 and the outer first and second ends 422, 424, respectively, is much greater than the thickness between the inner first and second lateral sides 416, 418 and the outer first and second lateral sides 426, 428, respectively. As may be appreciated, with this configuration, when the encased electromagnetic coil 114 is disposed around one of the stator poles 112 in FIG. 1 and is energized, heat will preferentially flow from the coil 118 to the stator pole 112.

As may be appreciated, instead of or in addition to the above, the thickness of one or both of the front facing or rear facing surfaces 406, 408 may also be selected such that, when the encased electromagnetic coil 114 is disposed around one of the stator poles 112 in FIG. 1 and is energized, heat will preferentially flow from the coil 118 to the stator back-iron 108. Moreover, instead of or in addition to one or more of these other techniques, the thickness between the inner first and second ends 412, 414 and the outer first and second ends 422, 424, respectively, may be selected such that, when the encased electromagnetic coil 114 is disposed around one of the stator poles 112 in FIG. 1 and is energized, heat will preferentially flow from the coil 118 to the end bells 110. It will be appreciated that numerous and varied other dimensional selection techniques could also be used in addition to or instead of those specifically disclosed herein.

Another dimensional selection technique includes molding the coil cartridge 122 into various geometries. For example, in the embodiment depicted in FIG. 4, the geometry of the coil cartridge 122 is generally elliptical. However, in other embodiments, and depending on the end use, the coil cartridge 122 may be molded to have a circular shape, a square shape, a rectangular shape, or an irregular shape, just to name a few. It will additionally be appreciated that the cross-sectional shape of one or more portions of the coil cartridge 122 may vary. For example, in the embodiments depicted in FIGS. 2 and 4, the cross-sectional shape of the mid-portions of the coil cartridge 122 (see FIG. 5) is generally square. In other embodiments, however, the cross-sectional shape of at least portions of the coil cartridge 122 could be other shapes, such as, for example, rectangular, triangular, trapezoidal, or any one of numerous other geometric shapes.

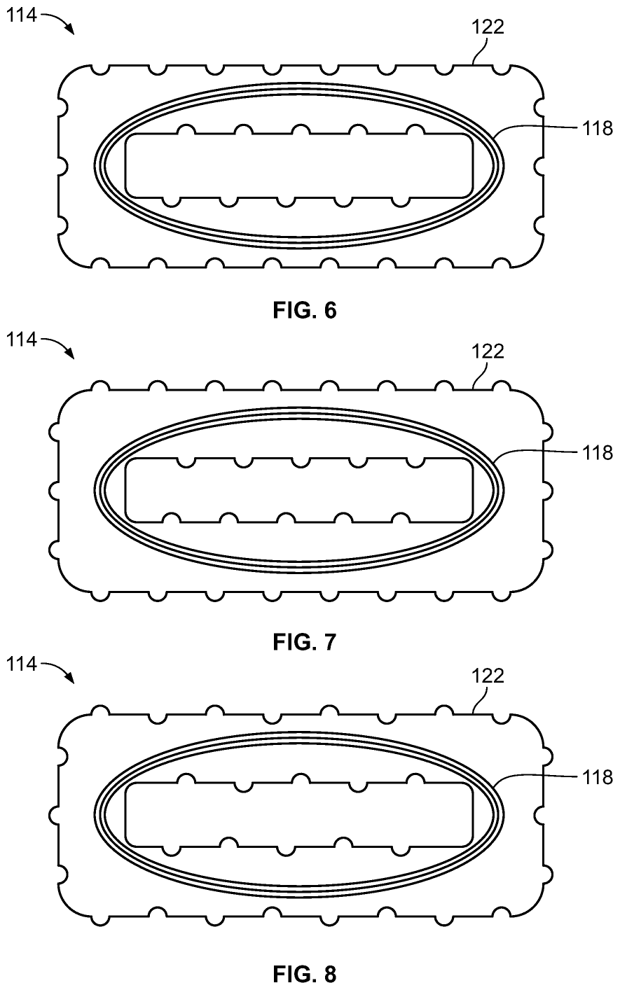

Yet another dimensional selection technique includes incorporating various contact points on one or more of the plurality of surfaces. For example, one or more indentations may be included on one or more of the plurality of surfaces (see FIG. 6), or one or more protrusions may be included on one or more of the plurality of surfaces (see FIG. 7), or a combination of both may be included on one or more of the plurality of surfaces (see FIG. 8). It will be appreciated that the number, dimensions, and spacing of the surface contact points (e.g., indentations and/or protrusions) may vary, as needed or desired.

Whether used alone or in combination, it will be appreciated that the dimensional selection techniques described herein may desirably result in the electrically insulating coil cartridge 114 exhibiting heat flow anisotropy. This allows the heat generated in the electromagnetic coil 118 to flow in an intentional and preferential direction without negatively impacting the properties of the electromagnetic coil. As such, with appropriately selected materials, the electromagnetic coils 118 disclosed herein can be operated at extreme operating conditions (e.g., temperatures that range from −60° F. up to at least 950° F.) as compared to the operating condition limitations associated with conventional electromagnetic coils.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for manufacturing an electromagnetic coil with an intentionally engineered heat flow path, the method comprising the steps of:
defining at least one preferential heat flow path for heat to flow for the electromagnetic coil;
designing a coil cartridge in which to encase the electromagnetic coil by selecting dimensions of different portions of the coil cartridge that will result in the at least one preferential heat flow path; and
encasing the electromagnetic coil in coil cartridge material to thereby produce an encased electromagnetic coil.

2. The method of claim 1, wherein the coil cartridge exhibits heat flow anisotropy.

3. The method of claim 1, wherein:
the coil cartridge includes an inner peripheral surface and an outer peripheral surface; and
selecting dimensions of different portions of the coil cartridge comprises incorporating at least one or more indentations on the inner peripheral surface, the outer peripheral surface, or both the inner and outer peripheral surfaces.

4. The method of claim 1, wherein:
the coil cartridge includes an inner peripheral surface and an outer peripheral surface; and
selecting dimensions of different portions of the coil cartridge comprises incorporating at least one or more protrusions on the inner peripheral surface, the outer peripheral surface, or both the inner and outer peripheral surfaces.

5. The method of claim 1, wherein:
the coil cartridge includes an inner peripheral surface and an outer peripheral surface; and
selecting dimensions of different portions of the coil cartridge comprises incorporating (i) one or more indentations on the inner peripheral surface, the outer peripheral surface, or both the inner and outer peripheral surfaces and (ii) one or more protrusions on the inner peripheral surface, the outer peripheral surface, or both the inner and outer peripheral surfaces.

6. The method of claim 1, wherein:
the coil cartridge has one or more cross-sectional shapes; and
selecting dimensions of different portions of the coil cartridge comprises varying the cross-sectional shapes of at least portions of the coil cartridge.

7. A method for manufacturing a motor stator assembly, the method comprising the steps of:
providing a stator structure having at least a plurality of spaced-apart stator poles, each of the spaced-apart stator poles extending radially therefrom;
defining at least one preferential heat flow path for heat to flow for each of a plurality of electromagnetic coils;
designing an associated coil cartridge for each of the electromagnetic coils by selecting dimensions of different portions of each of the associated coil cartridges that will result in the at least one preferential heat flow path for each of the electromagnetic coils;
encasing each of the electromagnetic coils in coil cartridge material to thereby produce a plurality of encased electromagnetic coils; and
disposing each of the encased electromagnetic coils around a different one of the stator poles.

8. The method of claim 7, wherein each coil cartridge exhibits heat flow anisotropy.

9. The method of claim 7, wherein:
each coil cartridge includes an inner peripheral surface and an outer peripheral surface; and
selecting dimensions of different portions of each coil cartridge comprises incorporating at least one or more indentations on the inner peripheral surface, the outer peripheral surface, or both the inner and outer peripheral surfaces.

10. The method of claim 7, wherein:
each coil cartridge includes an inner peripheral surface and an outer peripheral surface; and
selecting dimensions of different portions of the coil cartridge comprises incorporating at least one or more protrusions on the inner peripheral surface, the outer peripheral surface, or both the inner and outer peripheral surfaces.

11. The method of claim 7, wherein:
each coil cartridge includes an inner peripheral surface and an outer peripheral surface; and
selecting dimensions of different portions of the coil cartridge comprises incorporating (i) one or more indentations on the inner peripheral surface, the outer peripheral surface, or both the inner and outer peripheral surfaces and (ii) one or more protrusions on the inner peripheral surface, the outer peripheral surface, or both the inner and outer peripheral surfaces.

12. The method of claim 7, wherein:
each coil cartridge has one or more cross-sectional shapes; and
selecting dimensions of different portions of the coil cartridge comprises varying the cross-sectional shapes of at least portions of each coil cartridge.

13. The method of claim 7, wherein:
the stator structure further comprises a stator housing and a plurality of end bells; and
the at least one preferential heat flow path is one or more of:
an axially directed heat flow path toward the end bells,
a radially directed heat flow path toward or away from the stator housing;
an inwardly directed heat flow path toward the stator pole around which the encased electromagnetic coil is disposed, and
an outwardly directed heat flow path toward an adjacent encased electromagnetic coil.
